(19) United States
(12) Patent Application Publication
(10) Pub. No.: US 2020/0353576 A1
(43) Pub. Date: Nov. 12, 2020

(54) Mechanically Retained Seat for Valve Assembly

(71) Applicant: Gary W. Spangler, Wilmington, NC (US)

(72) Inventor: Gary W. Spangler, Wilmington, NC (US)

(21) Appl. No.: 16/409,865

(22) Filed: May 12, 2019

(51) Int. Cl. B23P 15/00

(52) U.S. Cl. CPC B23P 15/002

(57) ABSTRACT

A valve assembly may include a seat that is formed integrally (e.g., cast) into a dovetail shaped cavity. A portion of the seat is present above the surface of the disc according to a desired profile and to provide a bubble tight seal. Walls of the dovetail may include an angled surface (e.g., 45 degrees) for retention considerations. The dovetail may be cast, as opposed to machined, to reduce manufacturing costs. Additionally, the seat may be mechanically deformed before it can be removed.

### I. FIELD OF THE DISCLOSURE

The disclosure relates to valve systems, and more particularly, to check valves.

### II. BACKGROUND

Flow capacity in check valves can be compromised by the internal valve hardware used to form seals. Seals help minimize certain instances of pressure and fluid loss. Valve performance and longevity may suffer from seal deterioration and deformation over time.

### III. SUMMARY OF THE DISCLOSURE

According to a particular embodiment, an apparatus includes a valve assembly having a valve surface, wherein the valve assembly includes an aperture. Seat material may be configured to be positioned within the aperture. A surface of the seat material may be positioned at an angle relative to the valve surface.

The surface of the seat material may be part of a dovetail structure. In one embodiment, the seat material forms an approximately forty-five degree angle with regard to the valve surface. A portion of the seat material may extend above the valve assembly surface when the seat material is seated in the aperture. The seat material may extend above the valve assembly surface according to form part of a seal.

According to a particular embodiment, the seat material is molded into the aperture. The seat material may include at least one of rubber and a polymer and an elastomer. The seat material is formed integrally within the valve assembly. The seat material of an embodiment may be cast within the valve assembly. The seat material of an embodiment must be deformed before it can be removed from the valve assembly.

According to another particular embodiment, a method of manufacturing a valve includes forming an aperture within a valve surface and positioning a seat material within the aperture. A surface of the seat material may be positioned at an angle relative to the valve surface.

These and other advantages and features that characterize embodiments are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments.

### IV. BRIEF DESCRIPTION OF THE DRAWINGS

FIG. 1 is a cross sectional view of a valve assembly according to a particular embodiment;

FIG. 2 shows a top view of a portion of an embodiment of a valve assembly that includes a dovetailed seat;

FIG. 3 shows a side view of a portion of an embodiment of a valve assembly that includes a dovetailed seat; and

FIG. 4 shows a close up view of a dovetailed seat.

### V. DETAILED DESCRIPTION

A valve assembly may include a seat that is formed integrally (e.g., cast) into a dovetail shaped cavity. A portion of the seat is present above the surface of the disc according to a desired profile and to provide a bubble tight seal. Walls of the dovetail may include an angled surface (e.g., 45 degrees) for retention considerations. The dovetail may be cast, as opposed to machined, to reduce manufacturing costs. Additionally, the seat may be mechanically deformed before it can be removed.

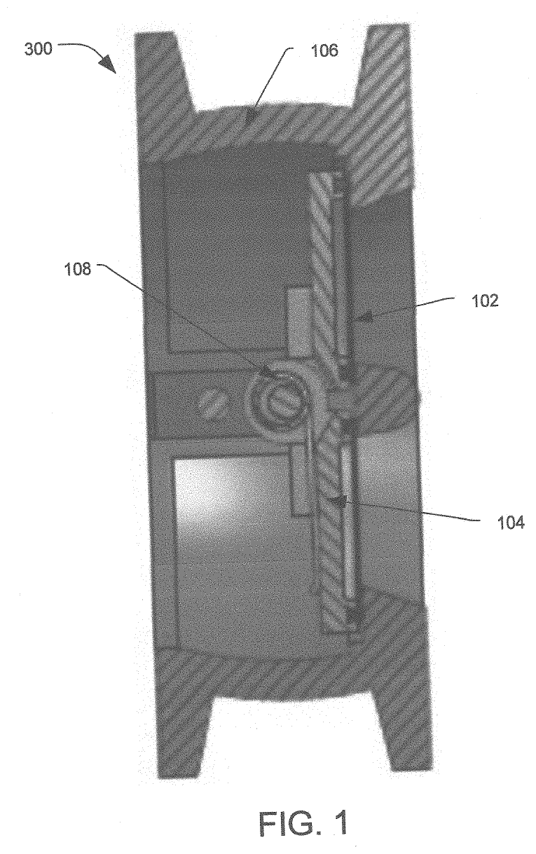

FIG. 1 shows an embodiment of a valve assembly 100 that includes a disc seat 102 that is formed integrally into a dovetail shaped cavity of a disc 104. The disc 104 may be positioned within a body 106 of the valve and may be biased by a spring 108. The seat 102 may not be removed unless it is mechanically deformed. According to a particular embodiment, the seat material 102 may include at least one of rubber, polymer, or an elastomer. The dovetail may be cast, as opposed to machined, to reduce manufacturing costs.

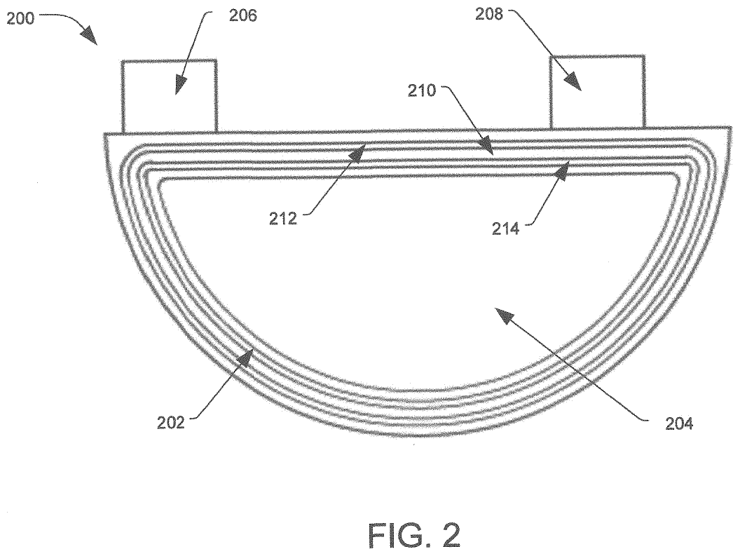

FIG. 2 shows a top view of a portion of an embodiment of a valve assembly 200 having a mechanically retained seat 202. The valve assembly 200 includes a disc 204 and disc lugs 206, 208. The valve assembly 200 may be similar to the valve assembly 100 of FIG. 1. As shown in the embodiment of FIG. 2, a center, bubble portion 210 of the seat 102 may extend up above flat portions 212, 214 of the seat 202.

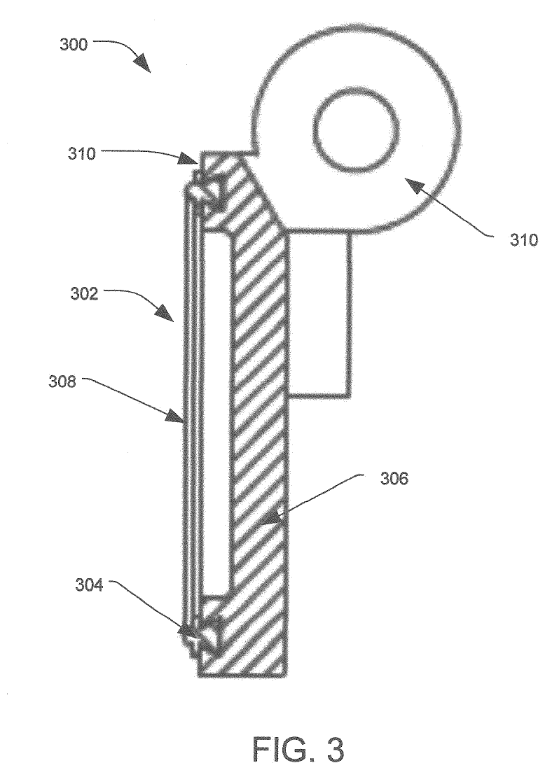

FIG. 3 shows a side, cross-sectional view of a portion of an embodiment of a valve assembly 300. The valve assembly 300 may be similar to the valve assemblies 100, 200 of FIGS. 1 and 2. The valve assembly 300 includes a seat 302 having a dovetailed portion 304 embedded into a disc 306. The disc 306 may be coupled to a disc lug 310. A portion 308 of the seat 302 may be present above a surface 310 of the disc 306 according to a desired profile and to provide a bubble tight seal.

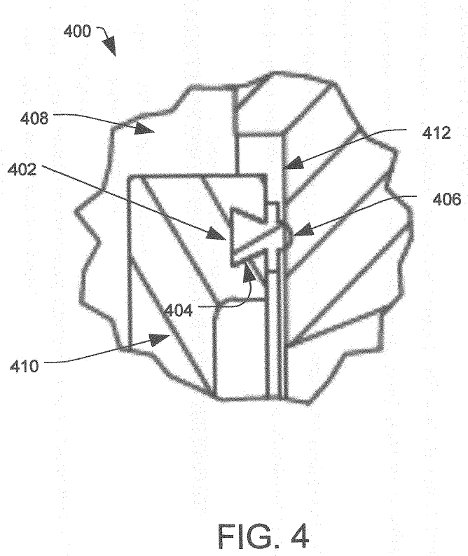

FIG. 4 is a close up, cross-sectional view of a portion of a valve assembly 400 that includes a dovetailed seat 402. Sides 404 of the dovetail seat 402 may include a 45 degree angle for retention considerations. One skilled in the art will appreciate that a range of degrees may be contemplated. A raised portion 406 of the dovetail seat 402 may have a rounded or other contoured surface, though other shapes may be used to facilitate a proper seal with an abutting surface 412. FIG. 4 also includes the body 408 of the valve assembly 400, as well as the disc 410.

Those skilled in the art may make numerous uses and modifications of and departures from the specific apparatus and techniques disclosed herein without departing from the inventive concepts. Consequently, the disclosed embodiments should be construed as embracing each and every novel feature and novel combination of features present in or possessed by the apparatus and techniques disclosed herein and limited only by the scope of the appended claims, and equivalents thereof.

1. An apparatus comprising:
a valve assembly having a valve surface, wherein the valve assembly includes an aperture; and
a seat material configured to be positioned within the aperture, wherein a surface of the seat material positioned at an angle relative to the valve surface.

2. The apparatus of claim 1, wherein the surface of the seat material is part of a dovetail structure.

3. The apparatus of claim 1, wherein the surface of the seat material forms an approximately forty-five degree angle with regard to the valve surface.

4. The apparatus of claim 1, wherein a portion of the seat material extends above the valve assembly surface when the seat material is seated in the aperture.

5. The apparatus of claim 4, wherein the seat material extends above the valve assembly surface according to form part of a seal.

6. The apparatus of claim 1, wherein seat material is molded into the aperture.

7. The apparatus of claim 1, wherein the seat material includes at least one of rubber and a polymer and an elastomer.

8. The apparatus of claim 1, wherein the seat material is formed integrally within the valve assembly.

9. The apparatus of claim 1, wherein the seat material is cast within the valve assembly.

10. The apparatus of claim 1, wherein the seat material must be deformed before it can be removed from the valve assembly.

11. A method of manufacturing a valve, the method comprising:
forming an aperture within a valve surface; and
positioning a seat material within the aperture, wherein a surface of the seat material positioned at an angle relative to the valve surface.

12. The method of claim 11, wherein the surface of the seat material is part of a dovetail structure.

13. The method of claim 11, wherein the surface of the seat material forms an approximately forty-five degree angle with regard to the valve surface.

14. The method of claim 11, wherein a portion of the seat material extends above the valve assembly surface when the seat material is seated in the aperture.

15. The method of claim 14, wherein the seat material extends above the valve assembly surface according to form part of a seal.

16. The method of claim 11, wherein seat material is molded into the aperture.

17. The method of claim 11, wherein the seat material includes at least one of rubber and a polymer and an elastomer.

18. The method of claim 11, wherein the seat material is formed integrally within the valve assembly.

19. The method of claim 11, wherein the seat material is cast within the valve assembly.

20. The method of claim 11, wherein the seat material must be deformed before it can be removed from the valve assembly.
